(19) United States
(12) Patent Application Publication
(10) Pub. No.: US 2003/0184673 A1
(43) Pub. Date: Oct. 2, 2003

(54) Automatic exposure control for digital imaging

(76) Inventor: Michael Skow, Mesa, AZ (US)

Correspondence Address: Michael C. Barrett, Fulbright & Jaworski L.L.P., Suite 2400, 600 Congress Avenue, Austin, TX, 78701, US

(21) Appl. No.: 10/115,474

(22) Filed: Apr. 2, 2002

(51) Int. Cl. H04N 5/238

(52) U.S. Cl. 348/364

(57) ABSTRACT

In exposure control of a digital image, a signal is obtained from an image sensor. One or more color channels are obtained from the signal. A mean value from one or more of the color channels is determined. A target exposure level is obtained. The difference between the mean value and the target exposure level is determined. An exposure correction is determined based upon the difference. The exposure correction is fed back to the image sensor, and one or more settings of the image sensor are adjusted corresponding to the exposure correction.

### BACKGROUND OF THE INVENTION

1. Field of the Invention

The invention relates generally to the field of digital imaging. More particularly, the invention relates to performing automatic exposure control on a digital image.

2. Related Art

As digital imaging becomes more prevalent, technology strives to achieve images and video with better resolution and color accuracy. One aim is to achieve images in which objects are exposed properly—i.e., not too bright or too dark, moving the digital information histogram to an optimal point within the bounds of the maximum and minimum output signal levels of the system. Another related aim is to achieve images that are properly exposed and which exhibit a high signal-to-noise ratio—i.e., properly-exposed images that do not show many noise artifacts. Conventional devices have not been able to achieve these aims. Instead, they provide images whose exposure is not optimized, and those images often suffer from a low signal-to-noise ratio.

Presently, most consumer digital cameras employ CCD or CMOS sensor(s). Typically, these sensors include a great number of pixels, or picture elements, that register information about the light falling on them. To facilitate the collection of light, many of the sensors employ a small lens-like structure covering each pixel, which is called a microlens. These microlenses are typically made by manipulating a layer of photoresist that is placed upon the pixel plane.

The image sensors used in digital imaging are inherently “grayscale” devices, having no color to them. For this reason, the sensors typically employ a color filter array (CFA) wedged between the microlens and an active portion of the pixel structure, the pixel well. Typically, the CFA is constructed to assign a single color to each pixel. Digital camera manufacturers often choose among a variety of CFA architectures, usually based on different combinations of primary colors (red, green, blue) or complementary colors (cyan, magenta, yellow). Regardless of the particular CFA used, the overall aim is to transfer only a single color of interest, so that each pixel sees only one color wavelength. CFAs also attempt to reduce color artifacts and interference between neighboring pixels, while helping with accurate color reproductions.

One of the most popular and ubiquitous CFAs is called the Bayer Pattern, which places red, green and blue filters over the pixels, in a checkerboard pattern that has twice the number of green squares as red or blue. The theory behind the Bayer Pattern is that the human eye is more sensitive to wavelengths of light in the green region than wavelengths representing red and blue. Therefore, doubling the number of green pixels provides greater perceived luminance and more natural color representation for the human eye.

When subjected to light, an image sensor, which includes a CFA such as the Bayer Pattern, converts incident photons to electrons and is hence within the analog realm. Next, the stored electrical charges arising from the light hitting the sensor's pixels are converted to a stream of voltages via, typically, a built-in output amplifier. This stream of voltages may then be sent to an external or on-chip analog to digital converter (ADC). The ADC converts the various voltage levels to binary digital data, placing the process now within the digital realm. In the DSP, the many points of data may be assembled into an actual image that is based on a set of built-in instructions. These instructions include mapping the image sensor data and identifying color and grayscale values of each pixel.

In a single sensor camera using a color filter array, one type of algorithm is called a demosaicing algorithm, which is used to derive color data per pixel. Demosaicing algorithms analyze neighboring pixel color values to determine the resulting color value for a particular pixel, thus delivering a full resolution image that appears as if each pixel's color value was derived from a combination of the red, blue, and green primary colors (if RGB colors are used). Thus, the assembled image can exhibit natural gradations and realistic color relationships.

Other types of algorithms allow the digital data to be further processed to achieve a particular color and intensity (or shade) associated with a specific pixel. Some of these algorithms tend to make pictures warmer (pinkish), while others produce cooler (bluer) results. Some set a default saturation level high, producing extremely bright, sometimes unnatural colors. Others choose a neutral, more realistic saturation, for greater subtlety and color accuracy.

Although such algorithms have shown a degree of utility in rendering accurate color representations, room for significant improvement remains. In particular, conventional techniques and algorithms have not been able to automatically process data such that digital image exposure is optimized, while achieving a high signal-to-noise ratio. Rather, problems arise—objects appear too dark or light and/or an image exhibits noisy characteristics.

In an attempt to address these shortcomings, some users of digital imaging equipment may turn to post image-acquisition software packages to correct for incorrect exposure. In particular, commercially available programs may be used to correct exposure and/or to attempt to remove the characteristics of noise. This may be accomplished, for example, by adjusting brightness, contrast, hue, and/or saturation values and by manually removing noise artifacts through the use of a “cloning” tool or “paintbrush” tool within the software.

Although these techniques offer the user a great range of flexibility and control in determining the properties of an image, the more post-acquisition corrections that are applied to an image, the more the overall quality of an image may degrade. For instance, heavy post-acquisition processing of an image may introduce unwanted digital artifacts. A similar phenomenon is known to film photographers, who recognize that a better print may be made from a good negative—better than a print made after applying multiple, albeit advanced, manipulations to a mediocre negative.

Based at least on the foregoing, it would be advantageous if users were provided with techniques that would produce an automatic, properly exposed and low-noise image directly from the digital device itself. This image would, in turn, not require much post-acquisition manipulation. Hence, one could obtain better final prints or other forms of output. Additionally, it would also be advantageous if users could avoid undue post-acquisition processing since that processing can often be very time consuming, requiring specialized knowledge that is very software-dependent, and which involves the use of expensive software packages intended to run on high-end computer equipment.

Any problems or shortcomings enumerated in the foregoing are not intended to be exhaustive but rather are among many that tend to impair the effectiveness of previously known digital imaging and processing techniques. Other noteworthy problems may also exist; however, those presented above should be sufficient to demonstrate that apparatus and methods appearing in the art have not been altogether satisfactory and that a need exists for the techniques disclosed herein.

### SUMMARY OF THE INVENTION

Embodiments of the present disclosure address shortcomings mentioned above by providing a new technique for achieving automatic exposure control of digital images, both still and video.

In one embodiment, the invention involves a method for performing exposure control of a digital image. A signal is obtained from an image sensor. One or more color channels are obtained from the signal. A mean value from one or more of the color channels is determined. A target exposure level is obtained. The difference between the mean value and the target exposure level is determined. An exposure correction is determined based upon the difference. The exposure correction is fed back to the image sensor, and one or more settings of the image sensor are adjusted corresponding to the exposure correction.

In another embodiment, the invention involves an apparatus for performing exposure control of a digital image. The apparatus includes an image sensor, a histogram calculation unit, a look-up table unit, and a communication unit. The histogram calculation unit is coupled to the image sensor and is configured to determine a mean value from one or more color channels from a signal of the image sensor. The look-up table unit is coupled to the histogram calculation unit and is configured to determine a difference between the mean value and a target exposure level and an exposure correction based upon the difference. The communication unit is coupled to the look-up table unit and is configured to feedback the exposure correction to the image sensor.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof; the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numerals (if they occur in more than one view) designate the same elements. It should be noted that the features illustrated in the drawings are not necessarily drawn to scale.

FIG. 1 illustrates a block diagram of an automatic exposure control method in accordance with embodiments of the present disclosure.

FIG. 2 illustrates a diagram of an automatic exposure and gain control method in accordance with embodiments of the present disclosure.

### DESCRIPTION OF ILLUSTRATIVE EMBODIMENTS

The invention and its various features and advantageous details are explained with reference to non-limiting embodiments and the accompanying drawings.

Embodiments of the present disclosure address shortcomings in the state of the art of digital imaging, such as those mentioned above, by providing methodology whereby effective exposure compensation and noise control is achieved prior to outputting a final digital image. In particular, embodiments described herein show how exposure compensations may be applied within a device itself; for example, image adjustments may be applied on a CMOS sensor chip or with a CCD sensor chip to achieve automatic exposure control.

In different embodiments, exposure corrections may be successively refined over time. For example, integration times and/or individual (or global) color gains of a sensor may be adjusted for exposure in response to the taking of a first image. In response to the taking of a second image, those adjustments may be modified and improved. In response to the taking of a third image, further modifications may be made. In this way, one may arrive at an optimal exposure correction scheme. Because the scheme may be applied within the device itself, prior to output, an end user need not worry about undergoing a long series of complicated post-acquisition exposure corrections that are time consuming, expensive, and potentially deleterious to overall image quality. Outputting an image that is already sufficiently corrected for exposure, and which exhibits low noise, is analogous to a photographer obtaining a perfectly-exposed and balanced negative—little, or no, post-acquisition manipulations are required, and thus, a better final image can be printed quickly, efficiently, and cost-effectively. The techniques of this disclosure work equally well under varying illumination conditions, providing even greater flexibility to the user.

Applications for the present disclosure are vast and include any application in which digital imaging and/or processing is involved. Embodiments may be applied to digital still and/or digital video cameras. Techniques of this disclosure are particularly well-suited for exposure correction on a Bayer Pattern digital image, although those having skill in the art will recognize that different CFA architectures may be used as well. Embodiments may be applied to digital imaging adapted for use not only in personal photography and videography, but also in medical, astronomy, physics, military, and engineering applications. Embodiments may be applied to devices utilizing one or any number of digital sensors.

Embodiments of this disclosure may be utilized in conjunction with a wide range of imaging system, including systems that use a complementary metal oxide semiconductor (CMOS) sensor having independent gain amplifiers for each of a set of four Bayer color levels or global gain settings. Embodiments may be utilized in conjunction with CCD sensors as well. Embodiments may also be utilized when an imaging system includes a digital processor that can provide adjustments to each color or global adjustments. Embodiments may be utilized via one or more computer programs, with an application specific integrated circuit (ASIC), or the like, as will be understood by those having skill in the art.

This disclosure entails at least two main embodiments. One embodiment provides methods and apparatus for automatic exposure control while another embodiment entails automatic exposure control that simultaneously acts to minimize the occurrence of noise within the exposure-corrected image. Both main embodiments perform exposure control on a captured digital image prior to its output via exposure compensations applied to the sensor itself. Both embodiments converge on a close approximation of the correct exposure in a short period of time and reduce or eliminate the need for post-acquisition exposure correction.

Automatic Exposure Control Embodiment

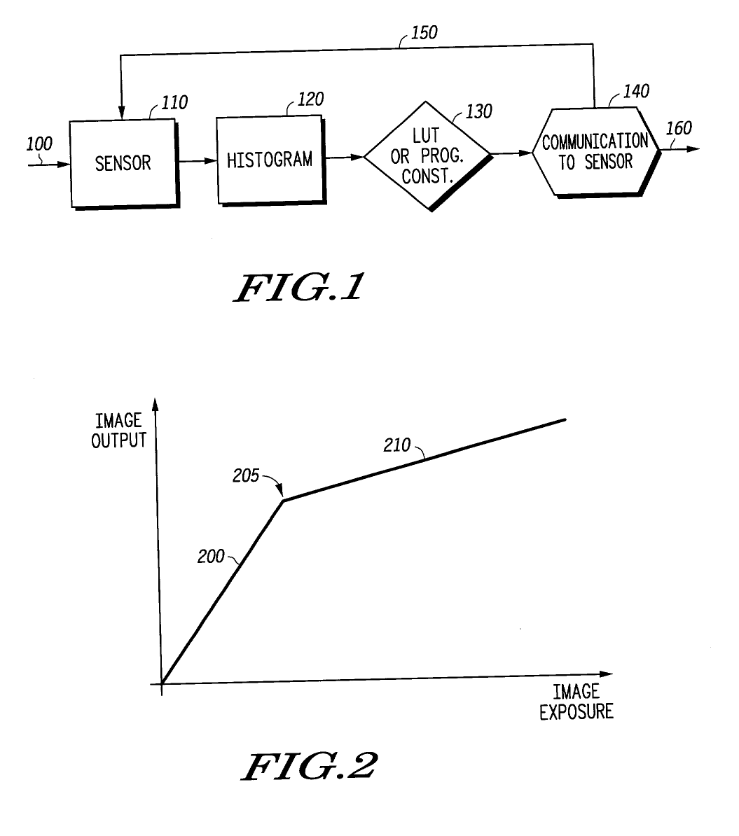

Referring to FIG. 1, a block diagram of an automatic exposure control (AEC) method is depicted. A data input 100 is coupled to a sensor block 110. In one embodiment, the sensor block may be a CMOS sensor. In another embodiment, it may be a CCD sensor. In different embodiments, the sensor block 110 may be made of a single, or multiple sensors. For instance, in one embodiment, the sensor block 110 may include three different sensors, each sensor concentrating on a different primary color. The sensor may include an electronic exposure integration setting, or this integration time control may be included in a separate device (not shown) coupled to sensor block 110. The integration time control is capable of dynamic control via a communication scheme, such as but not limited to I²C. The sensor may also include input-adjustable global gain or individual gains associated with individual colors.

The sensor block 110 is coupled to a histogram block 120. In one embodiment, the histogram block 120 may include software and/or hardware functionality that is able to generate one or more histograms from the output of sensor block 110. In particular, assuming an RGB color model, the histogram block 120 may be configured to generate a separate histogram for the red, blue, and green channels output from sensor block 110.

Histogram block 120 generates a histogram for the data in the scene being imaged. In general, histogram block 120 serves to calculate a median or mean value of the image (or one or more colors of the image), which is then used to arrive at an automatic exposure compensation. The automatic exposure compensation may be global, or color-by-color. In color-by-color embodiments, a different median or mean value may be determined for each of multiple colors of interest. Those median or mean values may then be compared against corresponding target exposure levels for those colors. In global embodiments, a single median or mean value may be determined (which may be based one or more colors), which is then compared against a single target exposure level.

In one embodiment, histogram block 120 calculates a median value of a particular area (or window) of interest within an image. The exposure of the window of interest then serves as a basis for the automatic exposure compensation. This window of interest may be, for instance, the bottom-half of the image. Selecting the bottom-half of the image may eliminate the bipolar averaging in outdoor ground/sky horizon images. In other words, focusing on the bottom half of an image may allow a more accurate exposure-related calculation since it avoids the overly-bright sun-lit sky that is common in most outdoor photographs. In indoor photographs, using the bottom-half of the image will suffice as well.

In another embodiment, histogram block 120 may find a median value of an area representing the image subject. In such an embodiment, it may be assumed that the main subject being photographed appears in, for instance, about the center 25% of the image. That region may then serve as the basis for median calculations (and eventually the automatic exposure compensation). Compensating an image based upon the center 25% of an image may result in evenly illuminating the subject, albeit at the relative expense of the dynamic range of the background. In other embodiments, different regions and/or sizes of areas of interest may be used to calculate the median. In other embodiments the center 1%, 5%, 10%, 15%, 20%, 30%, 35%, 40%, 45%, or 50% of the image may be used. Those having skill in the art, with the benefit of the present disclosure, will recognize that other window sizes and locations (i.e., other than a center area) may be used.

In one embodiment, the window of interest may be selected based upon the focus of the imaging device. For instance, in cameras having multiple auto-focus zones, the active focus zone may be used also as a window whose median value is calculated by histogram block 120 to be used for automatic exposure control. In still other embodiments, the window of interest may be calculated based upon one or more conditions of the image. For instance, the window of interest may be defined by regions having a particular illumination, or it may be based upon the location of one or more objects in an image (the locations of which may be found via appropriate edge detection or object recognition algorithms).

In another embodiment, histogram block 120 calculates a mean value of an entire image (rather than focusing upon a particular area of interest). Such an embodiment may be advantageous due to its relative simplicity.

Calculating the median or mean of an image, which serves as a basis for automatic exposure control, may involve the median or mean of one or more color channels (or of a composite color channel). In one embodiment, only one color from a CFA image may be used. In particular, green alone may be used from a Bayer CFA image since it is a wide-band filter and is more-sampled due to the nature of the Bayer architecture (Red, Green, Green, Blue). In other embodiments, different color(s) or combinations may be used with Bayer images or images utilizing different CFAs. In this way, automatic exposure control may be done on a global basis (i.e., one global exposure compensation is determined based on a single median or mean value) or on a color-by-color basis (i.e., multiple exposure compensations may be determined based on median or mean values for different colors).

The output of histogram block 120, a scalar median or mean value, is fed to look-up table (LUT) block 130. Like the histogram block 120, LUT block 130 may include software and/or hardware functionality. Its function, in one embodiment is to calculate the difference between the supplied median or mean value(s) of an image and one or more target exposure levels. By “target” exposure, it is meant that there is a desired exposure level about which the automatic exposure corrections converge. The target exposure level may be a global target exposure level or it may be tailored for a particular color.

In one embodiment, the target exposure level may be entered by a user. In another embodiment, the target exposure level may be set as a default value. In one embodiment, the target exposure level may be any value between 30% to 50% (inclusive) of the possible dynamic range. This lower-than-half value may compensate for the gamma correction of the image. In other embodiments, however, the target exposure level may be set or chosen to be, for instance, 15%, 20%, 25%, 55%, 60%, or 65% of the dynamic range. Those having skill in the art, with the benefit of the present disclosure, will recognize that a myriad of other target exposure levels may be used, depending upon, for instance, the effect the photographer is seeking to achieve.

The difference between the median or mean provided by histogram block 120 and the target exposure level of LUT 130 gives both the direction and magnitude of the desired global (or, in a different embodiment, color-by-color) exposure increases or decreases required to achieve exposure compensation. There are at least two embodiments that may be used to achieve this increase or decrease. In a first embodiment, a fixed lookup table (e.g., LUT 130) may be used to determine the appropriate exposure compensation. For instance:

if Median−Target=<<<0, then a large exposure increase is applied to the sensor;

if Median−Target=<0, then a small exposure increase is applied to the sensor;

if Median−Target≈0, then little if any exposure increase or decrease is applied to the sensor;

if Median−Target>>>0, then a large exposure decrease is applied to the sensor;

if Median−Target>0, then a small exposure decrease is applied to the sensor.

In different embodiments, the actual amount of the exposure increases or decreases may be varied according to, for instance, the number of iterations desired for exposure levels to converge to the target level. In one embodiment, the exposure increases or decreases may be relatively gradual so that the no “over-shooting” of exposure levels is implicated. In such embodiments, however, it may take longer for an exposure level to closely match the target level, but advantageously those changes may not be drastic. In other embodiments, increases or decreases in exposure may be done more aggressively. In such embodiments, although an exposure level may converge quicker towards a target level, one may experience drastic changes in exposure levels along the way. No matter whether a gradual or more aggressive exposure compensation scheme is desired, the specific amounts for exposure increases or decreases (and/or rules or algorithms for arriving at those increases or decreases as described herein) may be stored in LUT 130.

As an illustrative example, one can envision an overexposed image that is to be corrected using this methodology. The histogram of this output (e.g., a tabular listing of the number of occurrences of each output level) may be shifted to the upper end of the range of all values. In a scale from 0 to 255 (8 bits), the over-exposed example might have output data ranging from 200 to 255, with the numerical median of this data set being the value of 225.

The target value (the desired value to expose the image properly) may be on the order of 30% of the maximum value, or the value of 77. So the purpose of the algorithm would be to successively approximate the next output value, by changing the exposure level of the sensor based on the current output image.

In this example, the median value (225) less the target value (77) is>>>zero. The distance from zero indicates that a very large (but fixed) reduction in the integration time is required before the next image frame is captured. The reduction in the integration time will reduce all of the output values in the next image frame, and with them the median value of that data set. This new value will approach, but still may not equal the target value, and will again undergo the analysis/integration time change as did the previous image frame.

In a second embodiment, an absolute exposure increase or decrease may be applied, based upon the percentage difference between the target and measured exposure levels. For instance:

Exposure_{new}=Exposure_{current}+(% difference)*Exposure_{current}; or, rewritten

Exposure_{new}=Exposure_{current}*(1+(% difference)),

where (% difference) is the percentage difference between the Median (or mean) and Target values (a positive percentage representing that the Target is greater than the Median). Thus if the Target is 20% greater than the Median (or mean), then:

Exposure_{new}=Exposure_{current}*(1.20).

In other words, the new exposure is increased by 20%. LUT block 130 may perform this calculation to determine the appropriate exposure compensation to be relayed to the sensor block 110.

Turning again to FIG. 1, feedback block 140 is shown. In one embodiment, feedback block 140 outputs final image data for use and/or viewing via signal 160. It also feeds back, via feedback signal 150, integration time updates (and/or gain setting updates) to sensor block 110 based on the correction value(s) determined at LUT 130. In one embodiment, the feedback may be communicated by the communication method I²C. However, those having skill in the art will recognize that any other communication method suitable for transmitting information to sensor block 110 may suffice.

According to the foregoing, exposure corrections may be successively refined over time. Again, integration times and/or individual color gains (or global gain) of a sensor may be adjusted for exposure in response to the taking of a first image. In response to the taking of a second image, those exposure adjustments may be modified and improved. In response to the taking of a third image, further exposure modifications may be made. Those, over time, images are better and better automatically corrected for proper exposure.

In different embodiments, modifications need not be done after each and every frame is taken. For instance, in one embodiment, exposure modifications may be made after every third frame is taken. In other embodiments, modifications may be made after every second, fourth, fifth, sixth, seventh, eighth, ninth, tenth, eleventh, twelfth, thirteenth, fourteenth, fifteenth, sixteenth, seventeenth, eighteenth, nineteenth, twentieth, twenty-first, twenty-second, twenty-third, or twenty-fourth frame. In another embodiments, modifications may be made only after it is detected that overall illumination levels have changed. In other words, exposure corrections may be kept constant until it is detected that the photographer has switched to a different lighting environment. At that time, modifications may again be fed back to correct the sensor. Because, in accordance with embodiments herein, the exposure compensation is being applied to the sensor itself, the need for post-acquisition corrections to an image are reduced, or even eliminated.

Automatic Exposure Control & Noise Minimization Embodiment

This embodiment may be used with a sensor having both input adjustable global gain and integration time control. In general, maximizing the signal-to-noise ratio (SNR) of an image involves increasing an integration time to a maximum and decreasing a gain to a minimum.

In one embodiment, the output dynamic range of an image scene may be maximized by increasing exposure, until a maximum is reached, and thereafter increasing the gain, until a maximum is reached. This increasing may be done until the median or mean of the image (or portion of the image) has a substantially identical (e.g., in different embodiments, within 15%, 10%, 5%, 1%, 0.5%, or 0.1%) value to the exposure target value of the output range. In one embodiment, this exposure target value may be between about 30% and about 50% of the output range.

To decrease the output range, opposite types of corrections may be performed. In particular, gain may be reduced progressively, while the exposure is at a maximum, util the gain equals about one. Afterwards, the exposure may be reduced as needed.

Turning to FIG. 2, there is shown a plot illustrating such embodiments. Segment 200 represents an exposure adjustment, in which the gain remains unitary. Within this segment, the integration time is increased while keeping gain constant. The integration time reaches a maximum at point 205 in the graph. At this point, the gain is still one. If further increases in exposure are required past point 205 in the graph, the gain must be increased, while keeping the integration time at its maximum. Increasing gain, with integration time at its maximum, is shown by segment 210.

In sum, this embodiment increases integration time to its maximum (point 205) before gain increases are begun. This methodology reduces noise and therefore leads to better-quality images.

If exposure decreases are needed, one follows the curves from right to left in FIG. 2. Thus, gain is first decreased (while integration time is at its maximum) to a value of one at point 205. If further decreases are needed, the integration time is decreased, with gain remaining at a value of one.

The individual components described herein need not be made in the exact disclosed forms, or combined in the exact disclosed configurations, but could be provided in virtually any suitable form, and/or combined in virtually any suitable configuration.

Further, although the method of performing automatic exposure control described herein can be a separate module, it will be manifest that the method of may be integrated into any system with which it is associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by this disclosure, the appended claims, and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.”

What is claimed is:

1. A method for performing exposure control of a digital image, comprising:
obtaining a signal from an image sensor;
obtaining from the signal one or more color channels;
determining a mean value from one or more of the color channels;
obtaining a target exposure level;
determining the difference between the mean value and the target exposure level;
determining an exposure correction based upon the difference;
feeding-back the exposure correction to the image sensor; and
adjusting one or more settings of the image sensor corresponding to the exposure correction.

2. The method of claim 1, wherein the method is performed iteratively to refine the exposure correction and the settings.

3. The method of claim 1, wherein determining a mean value comprises determining a mean value for a window of interest within the image.

4. The method of claim 3, wherein the window of interest comprises the bottom-half of the image.

5. The method of claim 3, wherein the window of interest comprises the center 25% of the image.

6. The method of claim 1, wherein the target exposure level comprises between 30% and 50% of a dynamic range of the image.

7. The method of claim 1, wherein the feeding-back comprises feeding-back information using an I²C interface.

8. A method for performing exposure control of a digital image, comprising:
obtaining a signal from an image sensor;
obtaining from the signal one or more color channels;
determining a mean value from one or more of the color channels;
obtaining a target exposure level;
determining the difference between the mean value and the target exposure level;
determining an exposure correction based upon the difference;
feeding-back the exposure correction to the image sensor; and
if the exposure correction indicates an increase in exposure, increasing an integration time of the image sensor and then, only when a maximum integration time has been met, increasing a gain of the image sensor;
if the exposure correction indicates a decrease in exposure, decreasing a gain of the image sensor and then, only when a unity gain has been reached, decreasing an integration time of the image sensor.

9. The method of claim 8, wherein the method is performed iteratively to refine the exposure correction and settings of the image sensor.

10. The method of claim 8, wherein determining a mean value comprises determining a mean value for a window of interest within the image.

11. The method of claim 10, wherein the window of interest comprises the bottom-half of the image.

12. The method of claim 10, wherein the window of interest comprises the center 25% of the image.

13. The method of claim 8, wherein the target exposure level comprises between 30% and 50% of a dynamic range of the image.

14. The method of claim 8, wherein the feeding-back comprises feeding-back information using an I²C interface.

15. An apparatus for performing exposure control of a digital image, comprising:
an image sensor;
a histogram calculation unit coupled to the image sensor configured to determine a mean value from one or more color channels from a signal of the image sensor;
a look-up table unit coupled to the histogram calculation unit configured to determine a difference between the mean value and a target exposure level and an exposure correction based upon the difference; and
a communication unit coupled to the look-up table unit configured to feedback the exposure correction to the image sensor.

16. The apparatus of claim 15, wherein the apparatus comprises an application-specific integrated circuit.

17. The apparatus of claim 15, wherein the apparatus is integral with the image sensor.

18. The apparatus of claim 15, wherein the image sensor comprises a Bayer pattern image sensor.

19. The apparatus of claim 15, wherein the communication unit uses an I²C interface.
